(19) United States
(12) Patent Application Publication
(10) Pub. No.: US 2003/0130966 A1
(43) Pub. Date: Jul. 10, 2003

(54) Vehicle management, appraisal and auction system

(76) Inventors: Bruce T. Thompson, Plano, TX (US); Mark M. Rankin, Dallas, TX (US)

Correspondence Address: Jeffrey G. Degenfelder, Carstens, Yee & Cahoon, L.L.P., P.O. Box 802334, Dallas, TX, 75240, US

(21) Appl. No.: 10/326,493

(22) Filed: Dec. 20, 2002

Related U.S. Application Data
(60) Provisional application No. 60/342,296, filed on Dec. 20, 2001.

(51) Int. Cl. G06F 17/00

(52) U.S. Cl. 705/500

(57) ABSTRACT

An online data processing implemented system and method which assists used-car dealers in improving the operational efficiency of their used-car departments. The present invention overcomes many of the disadvantages of prior art data management systems by creating an improved data management system specifically focused on maximizing the operational efficiency of used-car departments. The improved system includes an Appraisal and Auction System and Vehicle Management System which collectively solves several challenges faced by used-car departments at dealerships, by complimenting and streamlining the day-to-day processes inherent in the operation of a used-car department.

### RELATED APPLICATIONS

This application claims the benefit, under 35 U.S.C. §119(e)(1), of U.S. Provisional Application Serial No. 60/342,296, filed Dec. 20, 2001, which is incorporated herein by this reference.

### BACKGROUND OF THE INVENTION

1. Technical Field

The present invention relates to information processing technology. More particularly, the present invention relates to an online data processing implemented system and method for assisting used-car dealers in significantly improving the operational efficiency of their used-car departments.

2. Description of the Related Art

Numerous data management systems are currently available to assist auto dealerships in maximizing the efficiencies of their operations. While several data management systems currently exist to assist new car operations in managing new car sales and trending, no customized automated data management systems currently exist to assist in the day to day management of operations in a potentially more profitable area of the auto dealership, the used-car department.

Used-car dealers take in significant numbers of trade-in vehicles each month as credit towards new or used car purchases. This reality creates several operational considerations unique to the effective operational management of a used-car department. First, dealers must determine through an appraisal process how much the trade-in vehicle is worth based upon market trends and preferences. Currently, dealers may use personal experiences and memory, calls to independent brokers and fellow dealers, and paper based, electronic or online guidebooks (such as NADA, NAAA, Black Book, Kelley Blue Book) to evaluate vehicles. However, because there are so many distinct and unrelated sources available to a used-car appraiser for determining the fair market value of a vehicle, in order to save time the appraiser must often choose only one or a few of these sources to determine the value of a particular vehicle. This inevitably leads to mistakes in the purchase price offered for trade-in vehicles resulting in profit loss to the dealer. Additionally, there are other intangibles that affect the marketability of a vehicle at a specific dealer's location (e.g., staff, advertising, location, etc.); therefore, guidebooks alone are not an accurate measure for vehicle values. Thus, there is currently a need for a single source that consolidates multiple guidebooks, markets, and broker information in addition to dealer specific factors in one location that can be accessed on a timely basis by appraisers.

Additionally, in order to keep track of potential trade-in vehicle appraisals, the majority of used-car dealers currently use a method comprised of duplicate or triplicate paper-based forms. These paper-based forms, called “appraisal sheets”, capture the vehicle identification number (VIN), basic vehicle information (such as make, model, body type, mileage, etc.), customer information, and detailed vehicle condition information. Currently, these forms are usually kept in card boxes and passed manually between sales and appraisal departments. In order to find an old appraisal, record file folders or card boxes must be sorted through. Present methods have effectively no reporting capability for the appraisal process to assist in evaluating trends in the appraisal and trade-in process.

Moreover, while dealers may take trade-in vehicles and sell them at retail from their used-car lot, the vast majority of trade-in vehicles must be disposed of through wholesale channels, i.e., wholesale auctions and independent wholesale brokers. Used-car dealers lose a significant percentage of profit on vehicles that are wholesaled through independent brokers. Vehicles that do not sell at one physical auction need to be transported to other physical auctions in different locations until the vehicle sells, consuming dollars in transportation costs as well as valuable staff time to personally attend the auctions. In addition, vehicles often stay on a dealer's lot for an extended period of time (average of 60 days) before they are sent to be wholesaled at physical auctions, thus further tying up significant amounts of money in vehicle inventory that will not sell at retail and the attendant inventory carrying/interest costs.

Currently, used-car department managers must often guess at what a trade-in vehicle will sell for at retail off their lot, inevitably resulting in operational inefficiencies in kept inventory (e.g., inventory which does not turn retail profits and/or eventually must be sold wholesale at a loss). Although there are currently several online auction venues for dealers, these online auction venues typically operate similarly to physical auction houses. Dealers typically post vehicles to these online auction sites only after they have lost money keeping the vehicle on their lot for an extended period of time, thus giving the dealers little benefit between physical auctions and online auctions.

Dealers also purchase vehicles at online and physical auctions to improve their retail used-car inventory mix in hopes of increasing their retail inventory turn rate and retail used-car profits. As with physical auctions, most online auctions limit buyers to looking at pre-determined “lanes” of vehicles for auction at a set time. Thus, buyers at online and physical auctions are typically forced to confine their purchasing to specific times. Although some online auctions do not confine vehicle sales to a certain time, they still require buyers to search through “lane” categories such as “Trucks” or “Sedans” for vehicles that the buyer needs. Additionally, buyers at online and physical auctions must guess at what kind of vehicles they need to purchase in order to maximize their retail profit and minimize the retail inventory turn time. Thus, there is currently a need for a alternative method of wholesaling used-cars through brokers and physical auctions in a more intelligent and operationally efficient manner to turn wholesale inventory quicker thereby avoiding costly inventory costs and wholesale losses.

Another operational consideration facing used-car department managers is optimizing the mix of vehicle inventory on their lots. Managers of used-car departments usually must rely upon experience and memory to determine how best to stock used-car retail inventory. This oftentimes leads to an aged inventory and/or a non-optimal inventory mix for the dealership, which in turn ultimately results in added inventory carrying costs and profit losses to the department. Additionally, used-car managers must also rely upon experience and memory recall when evaluating a trade-in vehicle for their retail lot. This inevitably results in lost profits and carrying costs when a trade-in vehicle, which should have been immediately sold through wholesale channels, is kept as a retail vehicle.

Currently, the inventory management and cataloguing system for many used-car departments merely consists of paper “inventory cards” that are kept in card boxes or files and old data (3-7 days late) from back office accounting systems. Additionally, the used-car departments of dealer groups currently have little means outside of fax and phone to access inventory at affiliated dealerships and vice-versa.

Therefore, a need exists for an improved and more comprehensive data management and inventory modeling system for use by used-car dealers. Further, a need exists for an improved data management system to assist used-car dealers in maximizing the operational efficiency of their day-to-day operations. A need also exists for an improved data management system to assist used-car dealers in analyzing the acquisition/selling trends of their inventory to optimize the makeup or mix of its inventory. Furthermore, a need exists for an improved data management system that allows used-car dealers to access information concerning inventory at affiliated dealerships. Finally, a need exists for an improved data management system which more efficiently facilitates the sale of used-vehicles between remotely located individuals thereby minimizing the “turn time” for a used vehicle.

### SUMMARY OF THE INVENTION

The present invention relates to an online data processing implemented system and method that assists used-car dealers in improving the operational efficiency of their used-car departments. The delivery of the present system also contains novel business methods. A critical enabler of the present invention is its incorporation of and adaptation to a network based infrastructure common to computer networks such as the Internet. The website centric business model of the present invention greatly enhances its accessibility by a multitude of participants.

The present invention overcomes many of the disadvantages of prior art data management systems by creating an improved data management system specifically focused on maximizing the operational efficiency of used-car departments.

The improved system includes an appraisal and auction system which collectively solves several challenges faced by used-car departments at dealerships, by complimenting and streamlining the day-to-day processes inherent in the operation of a used-car department. The appraisal and auction system enables used-car dealers to more accurately appraise the value of trade-in vehicles based upon multiple market sources by displaying consolidated, up-to-date vehicle valuation information. The appraisal and auction system also expedites the turn time of wholesale vehicles by accessing wholesale markets for used vehicles that are not time or location dependent thereby facilitating the receipt of bids to sell a trade-in vehicle at the time of the vehicle appraisal. In addition, the appraisal and auction system assists used-car dealers in determining which vehicles should be liquidated immediately through wholesale channels based upon dealer lot inventory historical trends generated by the system.

The improved system also includes a vehicle management system which helps used-car departments identify sales trends in their lot inventory and a resulting ideal inventory model, thereby assisting in developing an optimal inventory mix which correspondingly results in quicker inventory turn times and higher profits. The vehicle management system develops an optimal inventory mix for each particular dealership based upon an analysis of a plurality of vehicle criteria (e.g., make, model, color, seasonality, region, valuation, price, etc.). The vehicle management system also provides real-time advanced inventory management to dealerships through desktop and wireless handheld computer devices. Key features of the system include a real-time vehicle and inventory valuation, a real-time decision support system for vehicle trades, a dealer group inventory sharing functionality, inventory analysis functionality, and seasonal sales forecasting.

The recommendations provided by the ideal inventory model are an integral part of the decision support in the appraisal and auction system. The appraisal and auction system not only identifies the individual dealer's inventory needs at the time of vehicle appraisal, liquidation, or purchase, but also matches excess inventory supply and inventory demand between all dealers using the auction and appraisal system.

### BRIEF DESCRIPTION OF THE DRAWINGS

A more complete understanding of the method and apparatus of the present invention may be had by reference to the following detailed description when taken in conjunction with the accompanying drawings, wherein:

FIGS. 1a and 1b are pictorial representations of an embodiment of a distributed data processing system in which the present invention may be implemented;

FIG. 2a is a basic workflow diagram of an embodiment of the system of the present invention illustrating the direct import of data from a dealer's management systems into the vehicle management system database;

FIG. 2b is an alternate workflow diagram of an embodiment of the system of the present invention illustrating a dealer's management system file export and upload into the vehicle management system database;

FIG. 2c is an workflow diagram of an embodiment of the system of the present invention illustrating the upload of data from the vehicle management system database to a dealer's management system;

FIG. 3 is a basic workflow diagram of an embodiment of the system illustrating a remote data input and exchange of information for a vehicle coming in on trade;

FIG. 4 is a basic workflow diagram of an embodiment of the system of the present invention illustrating a remote data input and exchange of information for a vehicle going to online auction;

FIG. 5 is a alternative workflow diagram of an embodiment of the system illustrating remote data input utilizing a hand-held input device for used vehicles sold off the retail lot or at physical auction wherein the vehicle is already in system;

FIG. 6 is a basic workflow diagram of an embodiment of the system illustrating desktop data input for a consumer trade-in, an online auction, a sale off of retail lot, or physical auction;

FIG. 7 is a alternative workflow diagram of an embodiment of the system illustrating desktop sales information input for a retail or physical auction sale wherein the vehicle is already in system;

FIG. 8 is a basic workflow diagram of an embodiment of the system illustrating a vehicle record retrieval and update for dealership inventory;

FIG. 9a illustrates a main screen layout displayed to a user after login connecting to an embodiment of the system of the invention over a computerized network;

FIG. 9b further illustrates the vehicle summary screen embedded in the main screen layout displayed to a user in an embodiment of the system of the invention over a computerized network;

FIG. 9c further illustrates an alert summary screen embedded in the a main screen layout displayed to a user in an embodiment of the system of the invention over a computerized network;

FIG. 10a illustrates a the display screen layout displayed to a user when viewing information regarding a vehicle in an embodiment of the system of the invention over a computerized network;

FIG. 10b further illustrates the vehicle detail summary screen embedded in the display screen layout displayed to a user when viewing information regarding a vehicle in an embodiment of the system of the invention over a computerized network;

FIG. 11a illustrates an auction vehicle detail screen layout displayed to a user connecting to an embodiment of the system of the invention over a computerized network;

FIG. 11b further illustrates a watchlist summary screen embedded in the display screen layout displayed to a user when viewing the auction vehicle detail screen;

FIG. 12a illustrates a reports detail screen layout including a reports summary screen embedded therein displayed to a user connected to an embodiment of the system of the invention over a computerized network;

FIG. 12b illustrates a graphical summary of the Ideal Inventory Model Report generated by an embodiment of the system of the present invention;

FIG. 12c illustrates a detailed summary of the Ideal Inventory Model Report generated by an embodiment of the system of the present invention;

FIG. 13 is a basic workflow diagram of an embodiment of the system illustrating the process embodied in the Vehicle Trade Desk functionality of the present invention;

FIG. 14a illustrates the screen layout displayed to a user connecting the Vehicle Trade Desk set-up to an embodiment of the system of the invention over a computerized network; and

FIG. 14b illustrates a detailed summary of the Vehicle Trade Desk Report generated by an embodiment of the system of the present invention.

Where used in the various figures of the drawing, the same numerals designate the same or similar parts. Furthermore, when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the invention.

### DETAILED DESCRIPTION OF THE INVENTION

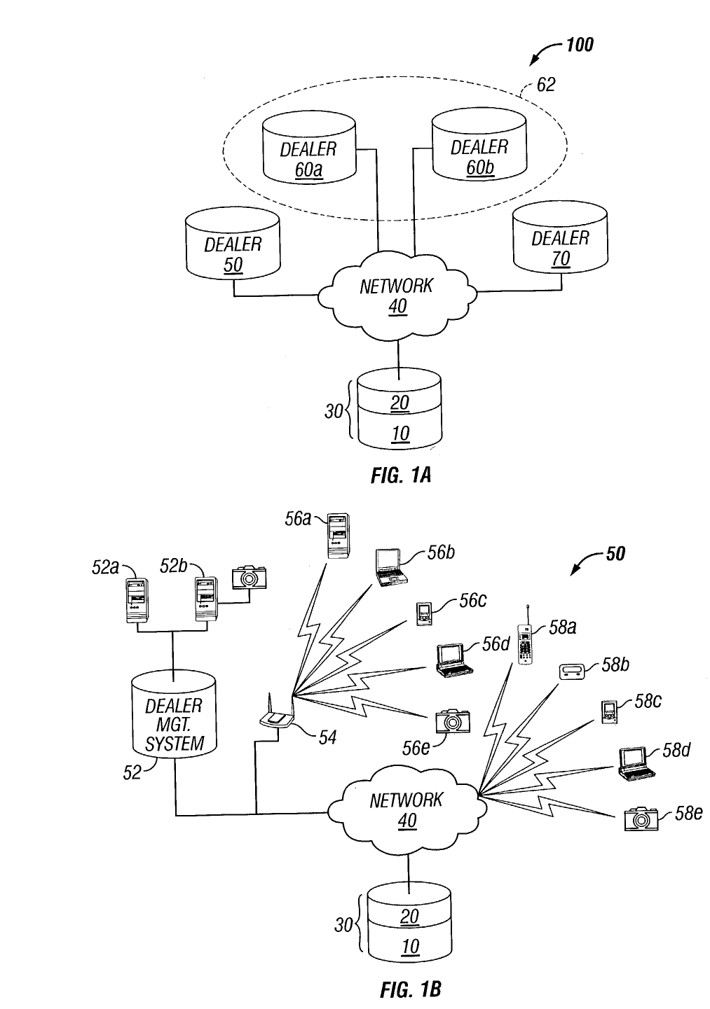

With reference now to the figures, FIGS. 1a and 1b are pictorial representations of a distributed data processing system in which the present invention may be implemented. A distributed data processing system is a network of computers in which the present invention may be implemented. The distributed data processing system 100 utilized by the system of the present invention includes a network 40, which is the medium used to provide communications links between various devices and computers connected together within the distributed data processing system. The network 40 may include permanent connections, such as wire or fiber optic cables, or temporary connections made through telephone connections or wireless applications.

In the depicted example, an application server 20 is connected to network 40 along with a main storage unit 10. In addition, client dealers 50,60a,60b,70 also are connected to network 40. As particularly shown in FIG. 1b, each client dealer (e.g., 50) may utilize a wide variety of computing devices including hand-held and/or wireless systems and devices 56a-e, 58a-e, personal computers 58d, network computers 52a,b, and other electronic devices to communicate with the system of the present invention. For purposes of this application, a network computer is any computer coupled to a network, which delivers or receives a program, data or other application from another computer coupled to the network. In the depicted example, the application server 20 provides data, such as boot files, operating system images, and applications to clients. The distributed data processing system may also include additional servers, clients, and other devices not shown.

In the depicted example, the distributed data processing system is the Internet, with network 40 representing a worldwide collection of networks and gateways that use the TCP/IP suite of protocols to communicate with one another. At the heart of the Internet is a backbone of high-speed data communication lines between major nodes or host computers, consisting of thousands of commercial, government, education, and other computer systems that route data and messages. Of course, a distributed data processing system may also be implemented as a number of different types of networks, such as, for example, an intranet, a local area network (LAN), or a wide area network (WAN). FIGS. 1a and 1b are merely intended as examples and not as architectural limitations for the present invention.

The present invention overcomes many of the disadvantages of prior art data management systems by creating an improved data management system specifically adapted to maximizing the operational efficiency of used-car departments. The improved system is comprised of an appraisal and auction system and a vehicle management system which collectively assist used-car departments in maximizing the efficiencies of their operations.

1. Overview of System Functionality

A. Auction and Appraisal System (AAS)

The improved system of the present invention includes an Appraisal and Auction System (AAS) which collectively solves several challenges faced by used-car departments at dealerships, by complimenting and streamlining the day-to-day processes inherent in the operation of a used-car department. The functionality of the AAS provides an automated appraisal system that provides consolidated market valuation information, inventory decision support information, and vehicle liquidation/sale capabilities at the time of the vehicle trade-in. The AAS assists used-car dealers by efficiently providing them with the following capabilities:

accurately review the value of trade-in vehicles based upon multiple market sources by receiving consolidated, up-to-date vehicle valuation information and dealer specific vehicle history,

expedite the turn time of wholesale vehicles from their lot by accessing wholesale markets for used vehicles that are not time or location dependent thereby facilitating the receipt of bids to sell a trade-in vehicle at the time of the vehicle appraisal,

predict what vehicles should be immediately liquidated through wholesale channels based upon past dealer lot historical trends, and

match the inventory excesses and deficiencies of one dealer to other dealers to facilitate inventory liquidation and fulfillment directly between dealers.

The AAS of the present invention is comprised of the following components/features/functionalities:

Imports information directly from dealer accounting systems, such as Reynolds & Reynolds, ADP EDS, Advent and UCS and other dealer management systems or data sources, to reduce duplicate inventory input into the system.

Look up of vehicle, vehicle options, and valuations by VIN or other vehicle-specific data.

Consolidation of vehicle valuation book data, including but not limited to Kelly Blue Book, Black Book, NADA, and NAAA valuation information.

Real-time market valuation information through vehicle bidding over the auction network of dealers and independent brokers.

Opportunity to place a vehicle for auction over the auction network at the time of appraisal.

Electronic means to store and retrieve vehicle appraisal and customer information for trending reports and future reference.

Electronic, industry standard appraisal forms and condition reports for appraisal records and accurate book valuation.

Integrated means to take and store photos of a vehicle during appraisal

Book sheets and other electronic forms to compliment manual dealer appraisal and trade-in processes.

Built-in electronic approval processes to allow used car and new car managers to approve appraisals of potential trade-in vehicles.

User specific permissions, such as a “sales person” role that allows the user to input vehicle trade-in information only.

Ability for buyers to view, bid and purchase only vehicles that meet their ideal inventory model. Rather than requiring the buyer to constantly monitor random vehicles offered at an online auction (or a physical auction), the AAS will alert the buyer if a vehicle that meets their inventory mix needs has been put up for auction.

Ability for buyers and sellers to use sealed bid and other processes to exchange vehicles based on their ideal inventory model

Ability for buyers to purchase vehicles by proxy bid.

Ability for sellers to automatically extend auctions.

Alerts for sellers indicating if a vehicle has been purchased of if reserve prices have been met for vehicles at auction.

A purchase now feature allowing the bidding to stop and the vehicle to be purchased at a pre-determined price set by the seller.

Regular alerts suggesting vehicle purchases or liquidations to meet maximum used-car retail profits and optimum retail turn times based on dealer historic sales trends.

Inventory liquidation or retention suggestions, at the time of a vehicle appraisal based on dealer historic sales trends.

B. Vehicle Management System (VMS)

The improved system also includes a Vehicle Management System (VMS) which helps used-car departments of auto dealerships identify trends in their lot inventory, thereby assisting in optimizing inventory mix which ultimately results in quicker inventory turn times and higher profits. The VMS is a data collection and reporting application that identifies the correct percentages and inventory mixes that will allow that dealership to realize a quicker turning inventory. The VMS identifies inventory mixes by make, model, color, seasonality, region, valuation, price, and other vehicle properties that will result in quicker inventory turns and higher profits.

The functionality of the VMS provides the used-car dealer with robust data mining and decision support information through an interface such as a desktop computer or a handheld device, not only in a standard reporting interface, but also in real-time as the dealer is making decisions on trade-in vehicles or auction purchases.

The VMS provides real-time advanced Inventory Management to dealerships through desktop and wireless computer devices. Key features of the system include real-time Vehicle and Inventory Valuation (VIV), real-time Decision Support System (DSS) for vehicle trades, Dealer Group inventory sharing, dealer inventory needs matching, inventory analysis, and seasonal sales forecasting.

The VMS allows dealerships to capture additional information on vehicles such as pictures, detailed text and audio descriptions, vehicle options, added options, and up-to-date valuations based on guidebooks such as National Automobile Dealers Association values (NADA), Kelly Blue Book (KBB) and Black Book National Auto Research (Black Book) values. Dealerships that are associated through a Dealer Group or dealer association will be able to access each other's inventories and match individual dealer needs, providing the added capability to swap vehicles directly between dealers based on ideal inventory models unique to each dealership.

The real-time Decision Support System (DSS) assists the dealership in determining whether a trade-in vehicle should be kept, auctioned, or sent to an associated dealership. Additionally, if a dealer is searching for vehicles on an online auction site incorporated into the system, the DSS will inform the dealer in real-time about specific auction vehicles that will meet their ideal inventory needs. This feature also provides a broader view of the entire inventory allowing dealerships to adapt their inventory to more closely match the seasonal sales forecast. A dealership's inventory needs can be met using the Inventory Sharing feature of the system, which identifies dealerships within the Dealer Group that have vehicles fitting a dealership's needs or vice versa.

The VMS of the present invention is comprised of the following components/features/functionalities:

Automated import of historical inventory and sales data from existing dealer accounting systems such as Reynolds & Reynolds, ADP, EDS, Advent and UCS.

Ongoing automated import and reconciliation of data from dealer accounting systems.

Ideal inventory modeling based on information including: historical dealer information, including make, model, type, year, mileage, season, valuation price band, cost, adjusted cost, sale price, wholesale or retail sales, gross profit, reconditioning cost, days on lot.

Ideal inventory model formulas based on vehicle cost per day, profit per day algorithms and an automated rating system based on dealer level trends.

Inventory searching, inventory data sharing, and trading between affiliated dealers of a dealer group or an AAX specified group.

Regular alerts suggesting vehicle purchases or liquidations for the dealer's current used-car inventory.

Multiple reports about current used-car inventory and historical used-car inventory.

Electronic vehicle records with search capability.

Ability to store photos and detailed condition reports with each inventory vehicle.

The following table delineates the hierarchy of access levels to one embodiment of the VMS of the present invention:

| NAME | REPRESENTS | ROLE |
|---|---|---|
| Service Provider | Service Provider For VMS | Accountable and responsible for all |
| | Services | development of the VMS system. |
| Dealer | Dealer System Input For The | Interfaces with VMS. Provides access |
| Management | VMS | and data input into the VMS system. |
| Systems | | |
| Dealer Group | End Customer Of VMS | Provides access to group data and |
| | | custom report needs for VMS. |
| | | Beneficiary of high level reports at group |
| | | level. |
| Dealer | End Customer Of VMS | Provides access and input of dealer |
| | | data and custom report needs for VMS. |
| | | Beneficiary of majority of reports. |
| Dealer | System Touchpoints For VMS | May provide data imports/input into the |
| Departments | | VMS system. (e.g., reconditioning totals |
| | | from Service department, imports from |
| | | the customer management system on |
| | | the sales/accounting side, other custom |
| | | application imports, etc. |

Additionally, as delineated in the following table, in one embodiment of the VMS of the present invention, each dealership has a corresponding internal hierarchy of access levels:

| NAME | DESCRIPTION/ROLE | STAKEHOLDER |
|---|---|---|
| Appraiser, Used-Car | Will input new inventory | Represented by a dealer or |
| Manager, or Used- | information at the time of trade-in, | dealer group. Each dealer or |
| Car Assistant | possibly all inventory given bar- | dealer group will identify |
| | code scanning. The Used-Car | specifically who will be |
| | Manager will also be the recipient | responsible for capturing |
| | of reporting and can specify | information and receiving |
| | custom reports. Will also have | reporting of the information. |
| | access to VMS decision support | |
| | for assistance with trade-in | |
| | decisions. | |
| General Manager | Will be recipient of reporting tools | Represented by a dealer or |
| | provided by the VMS | dealer group. Each dealer or |
| | | dealer group will identify |
| | | specifically who will have access |
| | | to reporting of the information. |
| Buyer/Seller for | Will have access to real-time cross | Represented by a dealer or |
| dealer, Used-Car | checking with VMS decision | dealer group. |
| Manager, or Used- | support to assist with wholesale | |
| Car Manager | purchase, sell decisions based on | |
| Assistant | inventory history. | |
| Salesman | May also input vehicle inventory | Represented by a dealer or |
| | information during the trade-in | dealer group |
| | process | |

The physical environment for VMS users will typically include the following locations:

outside at new/used vehicle sales lots;

at wholesale auctions, or places where wholesale auctions can be viewed, accessed or participated in;

while traveling;

inside at a desk or other work environment within a dealership; and

miscellaneous locations used-car manager may travel to.

In one embodiment of the present invention, there are four major components of customer use of the VMS:

1. Inventory data imports (from Reynolds & Reynolds, ADP, EDS, Advent, UCS, and other custom systems, other departmental systems such as services, or input from paper based records);

2. Inventory data capture, appraisal, and sharing;

3. Decision Support; and

4. Reporting

Inventory data imports will in most cases be done without dealer intervention. In some cases a dealer or dealer group may have a person designated to help enter information from paper records, which may require a UI into the system and take about 0.5-3.0 minutes per record to enter.

Inventory data capture is actively completed by a used-car manager, appraiser, or used-car manager assistant (e.g., 15 minutes—before, during, and after walking around and test driving a car). A salesman may also be responsible for entering part of the inventory information while they are working with a customer on a trade-in vehicle (e.g., 5 minutes) Additionally, a manager may be required to approve some information about the inventory input (e.g., the actual cash value (ACV)). Therefore the inventory input process will comprise or involve 1-3 people, taking a total time of 20 minutes during the trade-in process. In some cases, inventory input may occur before a car is input or put up on an online auction. This process may take 5 minutes.

Decision Support (DS) will be accessible when trading-in a vehicle (matching the VIN of potential trade-in), when purchasing vehicles at auction, searching through auctions, or when searching for or viewing inventory from their lot or other group dealer lots. In one embodiment of the present invention the DS may be a message, notification, or text output on the screen that will indicate if the car(s) fit in their ideal inventory mix (i.e., whether the vehicle should be put up for auction or kept for retail, etc.). This entire process will take no longer than it does currently to participate in auctions or do a vehicle search.

In one embodiment of the present invention, reporting may typically be run from a desktop computer or, on a more limited basis, from a mobile device. Managers will have the ability to pull custom or standard reports. Time spent pulling and reviewing reports may be from 5-30 minutes, depending on types of reports desired, especially if the manger chooses an ad-hoc type of reporting.

2. Overview of System Architecture and Methodology

The following description briefly summarizes the functionality of one embodiment of the components that comprise the system of the present invention.

A. Inventory Data Import

1. Dealer Management System (DMS) Data Import

The goal of the Accounting System Data Import feature is to provide sufficient historical data basis for the VMS by importing data from legacy accounting and management systems (e.g., ADP, Reynolds & Reynolds, EDS, Advent, and UCS) currently in use at customer dealer locations (ideally over past 2 years), as well as ongoing sales information to the VMS system.

a. Basic Workflow

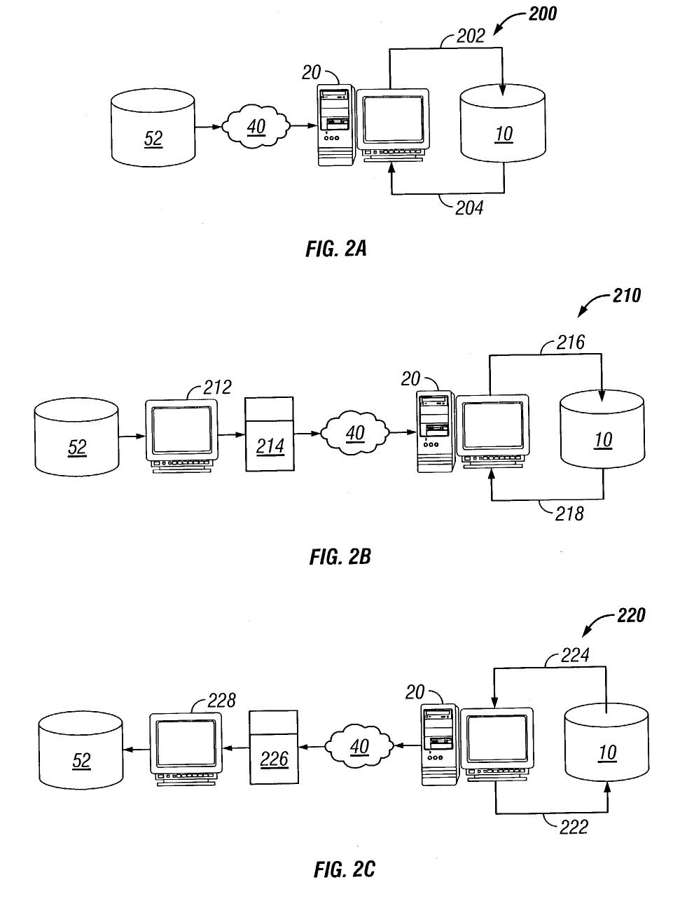

Referring now to FIG. 2a, which illustrates the basic workflow 200 of an embodiment of the system directly importing legacy accounting systems information into the VMS database. As shown, the VMS Application Server 20 captures data already contained in DMS (e.g., 52) currently in use at dealer's present location via network 40. After parsing the imported data, the Application Server 20 transfers 202 useable data to the VMS database 10. This data import will ideally capture the following data from legacy dealer management systems if available: VIN, year, make, model, body, series, color, mileage, type (truck, van, sedan), dealer stock number, interior color, all vehicle options, actual cash value, inventory status (e.g., pending trade-in/“be back”, in retail inventory, in wholesale inventory, sold), retail sticker price, sales price, where/how the vehicle was sold (e.g. retail, physical wholesale auction, wholesale through brokers, AAX wholesale), date the vehicle was purchased, date the vehicle was sold, who purchased the car, who sold the car, service and repair costs, part costs, service work orders and purchase orders, other reconditioning costs.

b. Alternative Workflow

FIG. 2b is an alternate workflow diagram of an embodiment of the system illustrating legacy dealer management system's file export and upload into the VMS. As illustrated, a data export file 214 is prepared by a scheduled file export 212 from the dealer's management system (e.g., 52). The scheduled file export is transferred via the network 40 to the VMS application server 20 wherein it is parsed and transferred to the VMS database 10. When required, the VMS database 10 sends data import exceptions 218 back to application server 20.

c. Upload Back to DMS

FIG. 2c illustrates the basic workflow 220 wherein data is uploaded via the network 40 from the VMS database 10 back to the legacy dealer management system. As will be understood by those with knowledge in the art, the data is selectively packaged by the application server 20 which interfaces with both the database 10 and the DMS (e.g., 52) via the network 40.

d. Functionality Categorization

While the Accounting System Data Import component of the present invention provides supporting functionality for the VMS, it is not a required component for the core operation of the system. The present invention further envisions the incorporation of real-time legacy accounting system imports, a reconciliation tool for inventory data and imports into legacy accounting system to reduce inventory input efforts.

B. Inventory Data Capture, Appraisal, and Management

1. Inventory Data Capture

In accordance with an embodiment of the system of the present invention, hand-held and or wireless computer devices are utilized to enable various dealer users to input inventory information into the system. The overall goal of hand-held and/or wireless inventory data capture is provide comprehensive vehicle information capture with minimal user effort. The data capture process should give the user some fringe benefit for using the system to input vehicle information.

a. Basic Workflow

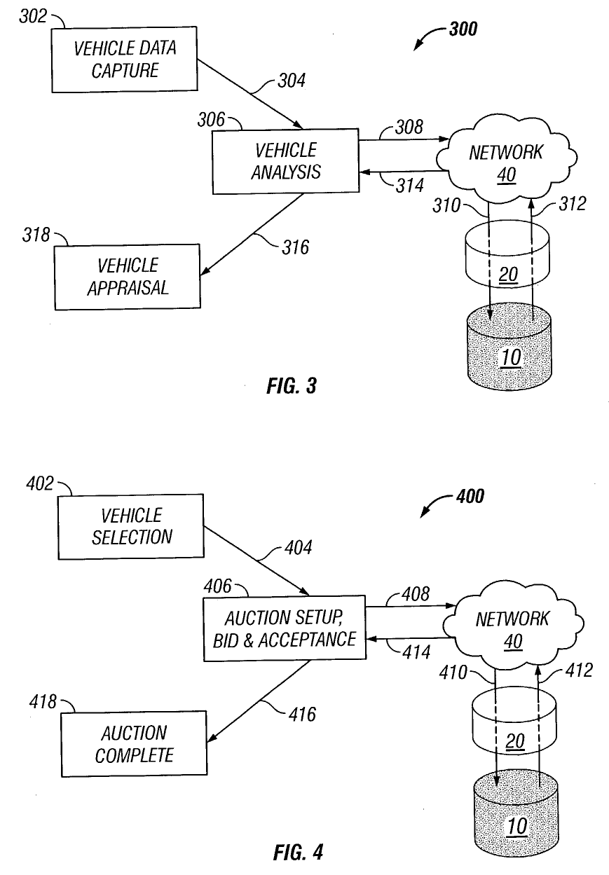

Referring now to FIGS. 3 & 4, which illustrate the basic workflow 300 of an embodiment of the system employing a hand-held and/or wireless device to capture data input 302 for vehicles coming in on trade or vehicles going to online auction. The data to be captured (i.e., entered and/or matched) throughout the inventory input process includes: trade-in customer information (e.g., name, number, address), VIN, year, make, model/body and series, type, mileage, exterior color, interior color, interior type, options, engine type, transmission type, odometer, glass condition (e.g., chipped, cracked, broken), paint condition (e.g., chipped/scratched, mismatched, oxidized, not original), body condition (e.g., dent, scratch, previous damage, etc), Overall Condition (e.g., Extra Clean, Clean, etc. according to Black Book or NADA terms), interior condition (e.g., clean, worn, burns, cracked, stains), Mechanical Condition (e.g., “damaged”, “OK”, or “N/A” for engine, front end, rear end, transmission, brakes, odometer, brakes, exhaust, air conditioning, Electronics, Emissions), wholesale or retail sales type, book valuations, actual cash value, reconditioning estimate, dealer stock number, Notes/Comments field, inventory status (e.g., pending trade-in, in-inventory, pending auction, pending finance, ready for pick-up). Once captured, the data is transferred via the network 40 back to the VMS application server 20 which in turn transfers it the VMS database 10. The VMS application server 20 thereupon correlates the data capture to recommend a range of appraisal values and sends appropriate information back to the user. Additionally, the system automatically captures the identity of the person who has appraised the ACV of the car (e.g., displayed as “Appraised by—______”) in the vehicle detail screen.

Referring now to FIG. 4, which illustrates the basic workflow 400 of an embodiment of the system employing hand-held and/or wireless data input for used vehicles being sold off the retail lot, the data to be entered and/or matched throughout the inventory input process is essentially the same as detailed in the preceding paragraph.

b. Alternative Workflows

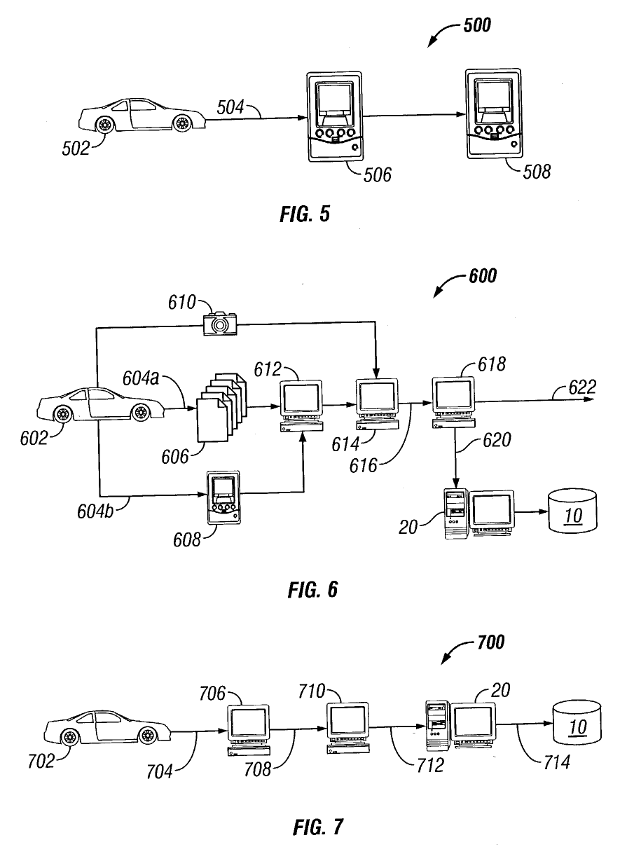

FIG. 5 is an alternative workflow 500 of an embodiment of the system illustrating hand-held and/or wireless input for used vehicles sold off the retail lot or at physical auction wherein the vehicle is already in system. As shown, the vehicle VIN is entered 504 into a wireless hand-held input device (e.g., a PDA), wherein in the system of the present invention provides a vehicle update screen 508 with vehicle information, options, condition, etc. and wherein the sales price may be input and where the vehicle was sold.

c. Functionality Categorization

The hand-held and/or wireless inventory data capture component of the system is a core capability of the VMS. The capture of complete inventory information as well as information on where and how the vehicle was sold is vital to the successful implementation of the system of the present invention. The present invention further envisions the use of tethered or wireless peripheral devices incorporating an integrated high-density bar code scanner for scanning data information into the system.

2. Desktop Inventory Data Capture

In accordance with an embodiment of the system of the present invention, desktop computer devices are utilized to enable various dealer users to input inventory information into the system. The overall goal of hand-held and/or wireless inventory data capture is provide comprehensive vehicle information capture with minimal user effort. The data capture process should give the user some fringe benefit for using the system to input vehicle information.

a. Basic Workflow

Referring now to FIG. 6, which illustrates the basic workflow 600 of an embodiment of the system employing a desktop computer to input data for vehicles coming in on consumer trade-in, online auction, sale off of retail lot, or physical auction, the data to be entered and/or matched throughout the inventory input process is the same type of information for the hand-held data capture (i.e., trade-in customer information (e.g., name, number, address), VIN, year, make, model/body and series, type, mileage, exterior color, interior color, interior type, options, engine type, transmission type, odometer, glass condition (e.g., chipped, cracked, broken), paint condition (e.g., chipped/scratched, mismatched, oxidized, not original), body condition (e.g., dent, scratch, previous damage, etc), Overall Condition (e.g., Extra Clean, Clean, etc. according to Black Book or NADA terms), interior condition (e.g., clean, worn, bums, cracked, stains), Mechanical Condition (e.g., “damaged”, “OK”, or “N/A” for engine, front end, rear end, transmission, brakes, odometer, brakes, exhaust, air conditioning, Electronics, Emissions), wholesale or retail sales type, book valuations, actual cash value, reconditioning estimate, dealer stock number, Notes/Comments field, inventory status (e.g., pending trade-in, in-inventory, pending auction, pending finance, ready for pick-up).) Additionally, the system automatically captures who has input the ACV of the car (e.g., displayed as “Appraised by—______”) in the vehicle detail screen. This should follow the same flow as the hand-held information capture except account for digital pictures uploaded by the user via diskette, cable from a digital camera, or scanner.

As shown in FIG. 6, the data regarding vehicle 602 may either be captured manually on paper appraisal sheets 606 or processed via a wireless device 608. However, even after initial capture, the data may need to be transferred to a desktop unit connected via network 40 to the system 30 comprised of VMS application server 20 and database 10 of the present invention.

b. Alternative Workflows

Referring now to FIG. 7, which illustrates an alternative workflow 700 of an embodiment of the system employing desktop sales information input for a retail or physical auction sale wherein the vehicle is already in system, the data to be entered and/or matched throughout the inventory input process is essentially the same as detailed in the preceding paragraph. The VIN 704 of the subject vehicle 702 is entered into the Vehicle Management Search Page 706 of the desktop unit which in turn produces a vehicle update screen 710 with vehicle info, options, conditions, etc. and input of sales price and where vehicle is sold. The update inventory information with sales price and timestamps is transferred 712 to the VMS application server 20 and thereupon to the VMS main database 10.

c. Functionality Categorization

The desktop inventory data capture component of the system is a core capability of the VMS. The capture of complete inventory information as well as information on where and how the vehicle was sold is vital to the successful implementation of the system of the present invention. The present invention further envisions utilizing accounting system data imports for sales information updates rather than requiring the used-car manager to update records.

3. Vehicle Record Retrieval and Update

In accordance with an embodiment of the system of the present invention, a vehicle record retrieval and update functionality is utilized to enable various dealer users to retrieve used-car inventory information for their lot as well as used-car inventory information from other network dealers. The overall goal of the vehicle record retrieval and update functionality is to provide comprehensive vehicle search and matching capabilities within the dealer, between dealers belonging to a network, and between independent dealers.

a. Basic Workflow

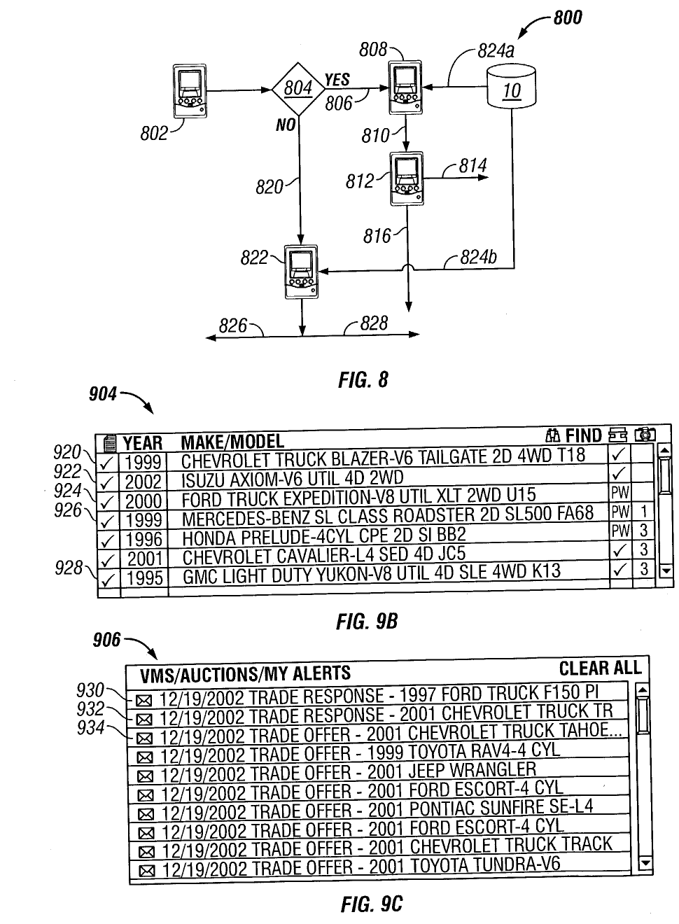

Referring now to FIG. 8, which illustrates the basic workflow 800 of an embodiment of the system utilizing the vehicle record retrieval and update functionality for dealership inventory. As illustrated, the dealer accesses the VMS search page to search for a particular vehicle by make, model, series, body mileage, valuation or type 802. The search may be either within 806 or outside of 820 the dealership. If within the dealership 806 then the search results 808 will list one record per line listing VIN, make, model, body, series, type, year, mileage, valuation, possible inventory status and inventory type as well as “task list” key. The VMS application server 20 in conjunction with VMS main database 10 sends appropriate Decision Support messages 824a (e.g., whether the vehicle should be kept in the inventory for retail or whether the vehicle should be sent to auction, or if another affiliated group dealership could use the vehicle). The dealer user can then decide whether to send the vehicle to an online auction set-up 814 or to send alerts/messages to affiliated dealers for trades 816.

On the other hand, if the dealer user decides search outside the dealership 820, the search results 822 will reflect a wider area search. The VMS application server 20 in conjunction with VMS main database 10 will also send appropriate Decision Support messages 824b (e.g., whether the vehicle should be kept in the inventory for retail or whether the vehicle should be sent to auction, or if another affiliated group dealership could use the vehicle). In this case the dealer user can decide whether to add the vehicle to his manage task list 826 or to send alerts/messages for dealer trades 828.

Regardless of whether the dealer decides to stay within the dealership inventor or go outside of the inventory, the process is greatly condensed thereby becoming more efficient.

The following data can be updated by a standard user of the system: trade-in customer information (e.g., name, number, address), mileage, exterior color, interior color, interior type, options, engine type, transmission type, odometer, glass condition (e.g., chipped, cracked, broken), paint condition (e.g., chipped/scratched, mismatched, oxidized, not original), body condition (e.g., dent, scratch, previous damage, etc), Overall Condition (e.g., Extra Clean, Clean, etc. according to Black Book or NADA terms), interior condition (e.g., clean, worn, burns, cracked, stains), Mechanical Condition (e.g., “damaged”, “OK”, or “N/A” for engine, front end, rear end, transmission, brakes, odometer, brakes, exhaust, air conditioning, Electronics, Emissions), wholesale or retail sales type, Notes/Comments field, inventory status (e.g., pending trade-in, in-inventory, pending auction, pending finance, ready for pick-up), and photos.

The following data can be updated only by a manager or corporate level user: book valuations, actual cash value, reconditioning estimate. Additionally, the following data will be displayed but may not be updated once a vehicle is input into the system: dealer stock number, VIN, make, model, body, series, type, year, time on lot (e.g., current date—date purchased)

The system also captures the following information somewhere during the update process: who sold the vehicle, how much the vehicle was sold for, retail sales price (if applicable), where the vehicle was sold.

b. Vehicle Record Retrieval for System Network Inventory

An embodiment of the system of the present invention also includes the capability to share inventory information between system users. A dealer user will have the ability to search for types of vehicles in other network dealer's inventories. Also provided is an option to search for inventory within a dealer group or outside the dealer group (which may be limited at the administration level, i.e., a dealer group may decide that their dealers can only share inventory within the dealer group). Any inventory sharing will occur only with dealers who have opted to share inventory on the system network (i.e., any dealer who does not want to make their inventory visible to all system network members will not be searchable). Additionally, all search results will be anonymous at the dealer level (i.e., the results will not indicate what dealer has the inventory, it will only indicate the approximate distance to that dealership). However, the manager/corporate level users will be able to see a dealer's identity within the group network.

Information displayed for a group network or system network search will include the following: VIN, make, model, body, series, type, year, mileage, color, and valuation(s). A link to the vehicle detail will display all of the previously displayed vehicle information plus the condition (e.g., overall, exterior, interior, mechanical), inventory status (e.g., pending trade-in, in inventory, pending auction, pending finance, awaiting pickup), inventory type (e.g., wholesale, retail), recon estimate, and any notes. Information that will not be displayed includes the following: ACV, time on lot, when vehicle was purchased, who appraised the vehicle.

c. Functionality Categorization

The vehicle record retrieval and update functionality of the system is a core capability of the VMS. The ability to retrieve as well as update vehicle record information is vital to the successful implementation of the system of the present invention.

4. Decision Support Upon Consumer Trade-In

In accordance with an embodiment of the system of the present invention, a decision support upon consumer trade-in functionality is available to alert an appraiser or used-car manager during a trade-in appraisal to indicate if the trade-in vehicle matches the ideal inventory mix for the dealer used-car retail lot, and if not, if other dealers in the system network or the dealer group network could use that vehicle for their inventory mix. The overall goal of the functionality being to query vehicle trending information to assist an appraiser or used-car manager in determining how the current consumer trade-in fits with the dealer's ideal used-car inventory mix.

This decision support component of the system is a core capability of the VMS. The present invention further envisions querying not only the particular dealer's lot trends but also querying similar dealer lot trends.

5. Decision Support Upon Auction Search For Purchase

In accordance with an embodiment of the system of the present invention, a decision support upon auction search for purchase functionality is included to alert a buyer (e.g., independent or dealer buyer/used-car manager) during a search for an auction vehicle or when accessing lanes or watchlists to indicate if that vehicle or vehicle lane matches the ideal inventory mix for the dealer used-car retail lot. The system will also produce alerts upon new auction vehicle sign up in the system network to notify dealers that an auction vehicle fits their ideal inventory mix. The overall goal of the functionality being to query vehicle trending information to help an appraiser or used-car manager determine how the current consumer trade-in fits with the dealer's ideal used-car inventory mix.

This decision support component of the system is a core capability of the VMS. The present invention further envisions querying not only the particular dealer's lot trends but also querying similar dealer lot trends.

6. Decision Support Upon Inventory Search

In accordance with an embodiment of the system of the present invention, a decision support upon inventory search functionality is available to alert a user during a search through their inventory or other dealers' inventories to indicate if a vehicle or vehicle lane matches the ideal inventory mix for the dealer used-car retail lot, or if the vehicle should be auctioned. The system will also produce alerts (e.g., on a daily, weekly, or monthly basis) to inform the dealer how their retail inventory matches their ideal inventory mix and how they may meet their ideal inventory mix. The overall goal of the functionality being to query vehicle trending information to help an appraiser or used-car manager determine how the current consumer trade-in fits with the dealer's ideal used-car inventory mix.

This decision support component of the system is a core capability of the VMS. The present invention further envisions querying not only the particular dealer's lot trends but also querying similar dealer lot trends.

C. Inventory Data Report

The system of the present invention includes the capability of generating trend reports based upon an analysis of information compiled in the system.

1. Trend Reports For Single Dealer Inventory By Vehicle Properties

In accordance with an embodiment of the system of the present invention, trend reports for a single dealer inventory by vehicle properties may be generated by the system. The overall goal of such a report being to query the vehicle trending information to help an appraiser or used-car department manager determine how the current consumer trade-in fits with the dealer's ideal used-car inventory mix, and what types of cars move the fastest and make the most money

a. Vehicle Property Trends Reports Details

The system can generate weekly and monthly reports listing the number of used vehicles purchased and used vehicles sold vs. days on lot and the average number of cars in inventory that week or month. The results of the report may include a calculation of the percentage of cars out of the total average inventory that are sold each month, and also the total percentage of inventory sold that month that were less than 30 days in inventory.

Additionally, the system can also generate an Inventory Turn Report, which comprises weekly and monthly report listing vehicles ranked by days in inventory (e.g., ascending or descending), grouped by relevant car properties. Primary properties may be year, make, model, series, body, color, and price. Reports may also be generated which report on vehicles sold within 10 days, 20 days, 30 days, 45 days, and 60 days. There should also be a variation on this report that groups these results by profit (e.g., price in—price out—reconditioning costs).

Probability Reports may also be generated by the system based upon historical vehicle property data to identify which cars have the highest probability of selling from that lot within a fixed period of time.

b. Functionality Categorization

The trending reports component of the system is a core capability of the VMS. The present invention further envisions querying not only the particular dealer's lot trends but also querying similar dealer lot trends.

2. Trend Reports For Single Dealer Inventory By Seasonality

In accordance with an embodiment of the system of the present invention, trend reports for a single dealer inventory by seasonality may be generated by the system by identifying from historical data any profitability or sales volume trends by seasonality. The overall goal of such a report being to query vehicle trending information to assist a used-car manager in determining how his ideal used-car inventory mix changes with seasons.

a. Seasonality Reports Details

The system can generate quarterly report listing number of used vehicles purchased vs. used vehicles sold vs. days on lot and the average number of cars in inventory in that time period. This report is accompanied by a graph indicating sales volume (or inventory turn %) changes over time. The report also calculates inventory turn percentages.

Additionally, the system can also generate quarterly reports comparing the inventory turn trends by quarter/season to profitability (i.e., gross and net). A variation of this report will also provide a drill down to vehicle properties. Quarterly reports comparing inventory turn trends by quarter/season to major vehicle properties (e.g., year, make, model, body, series, color) are also available. These reports should also be able to identify significant groupings of vehicle options (e.g., air conditioning, 4wd, etc.)

Probability Reports may also be generated by the system based on historical sales and vehicle property data, identify what cars have the highest probability of selling from that lot in a particular season at highest profitability.

b. Functionality Categorization

The trending reports component of the system is a core capability of the VMS. The present invention further envisions querying not only the particular dealer's lot trends but also querying similar dealer lot trends.

3. Trends Report For Multiple Dealer Inventory By Region

In accordance with an embodiment of the system of the present invention, trend reports for a multiple dealer inventories by region (inter-dealer group) may be generated by the system by identifying profitability and inventory turn trends in a particular region within a dealer group and outside a dealer group. This type of report may also be provided to corporate users for macro trending information. The overall goal of such a report being to query vehicle trending information to assist an appraiser or used-car department manager in determining how the current consumer trade-in fits with the dealer's ideal used-car inventory.

a. Basic Workflow

The system can generate reports detailing average inventory turn rates by dealer, by region; average profit (e.g., net and gross) by dealer, region. Each report will also have drill down capability to identify vehicle types, vehicle properties, and price ranges.

b. Functionality Categorization

The trending reports component of the system is a core capability of the VMS. The present invention further envisions querying not only the particular dealer's lot trends but also querying similar dealer lot trends.

3. Computer Screen Layouts

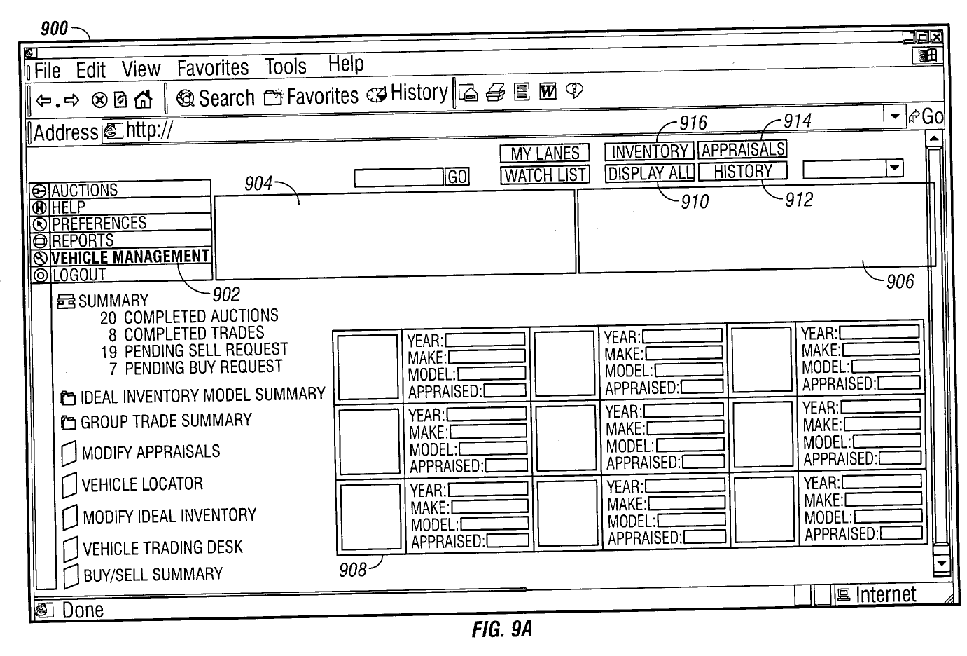

Referring now to FIGS. 9a-14b, authorized users of the system may access the system of the present invention via a computerized distributed data processing network such as the Internet. FIG. 9a illustrates the main screen layout displayed to a user after login to the invention over a computerized network. In accordance with procedures long practiced in the art and commonly known as “point and click,” users system may access the various functionalities of the system by pressing a mouse button pointed to various on-screen “buttons.” By pointing and clicking the on-screen buttons illustrated in FIGS. 9a-14b, a user will access the correlated functionality illustrated.

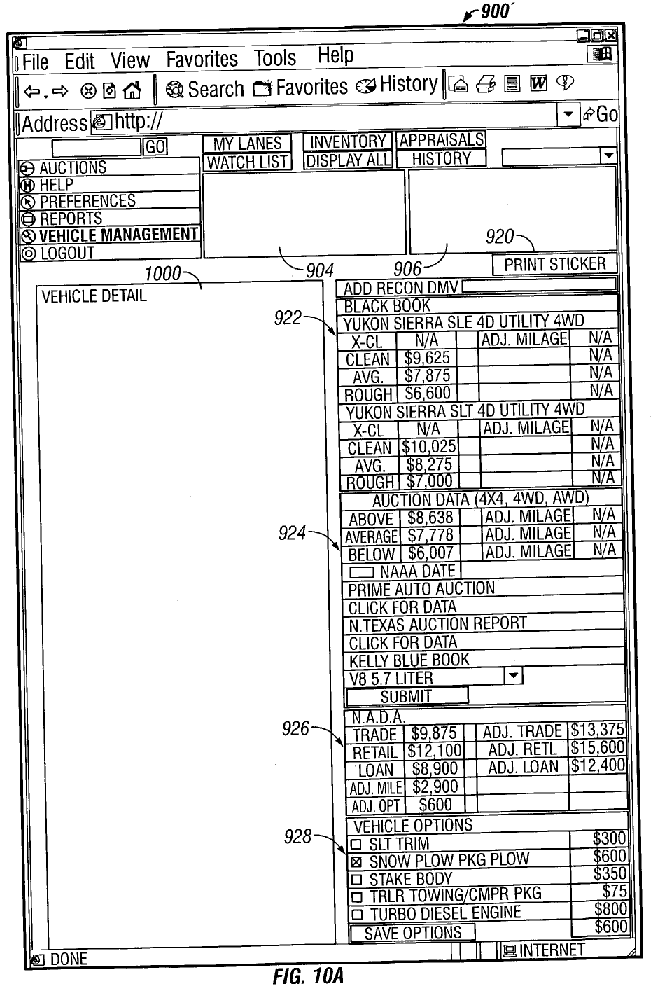

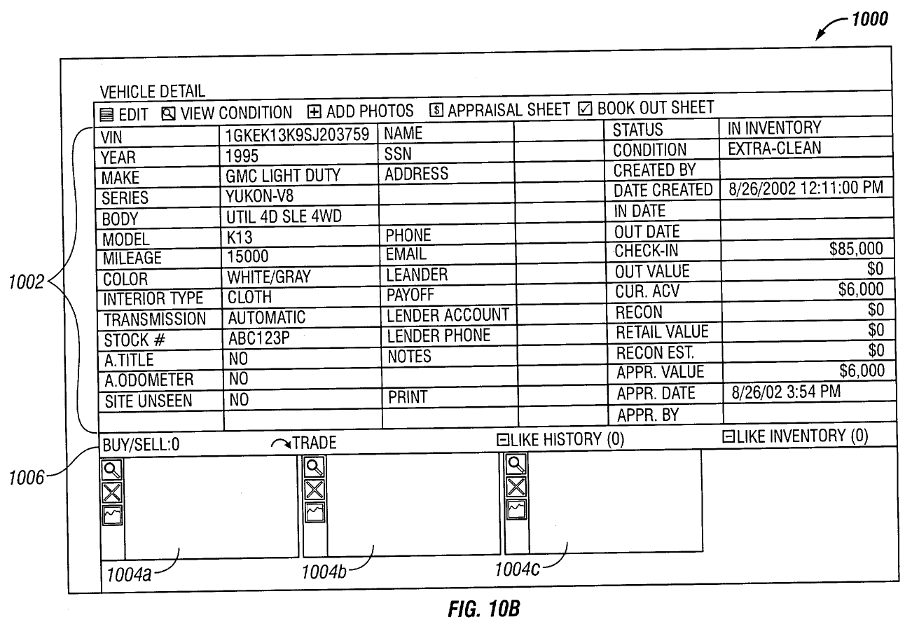

FIG. 9a illustrates a main screen layout 900 displayed to a user after login connecting to an embodiment of the system of the invention over a computerized network. The Vehicle Management onscreen button 902 is highlighted indicating that the default display is set to display the vehicle management capability of the system. A vehicle summary screen 904 and an alert summary screen 906 are embedded in the main screen and efficiently displays a variety of summary information depending upon which information select buttons 910, 912, 914, 916 is activated. As shown in more detail in FIG. 9b, the vehicle summary screen 904 displays lines of vehicles 920, 922, 924, 926 etc., in user's inventory. All of the vehicles listed is hyperlinked to a page containing more detailed information. Thus, for example, if the 1995 GMC vehicle 928 is activated by double-clicking, the original main screen layout 900 expands as shown in FIGS. 10a-b to include a vehicle detail summary screen 1000 and a composite appraisal screen 920. The composite appraisal screen 920 contains a compilation of several guidebook appraisals 922, 926 as well as current auction data 924. Thus, virtually instantly the dealer user has an abundance of pertinent information from which to determine his own opinion as to the worth of the particular vehicle. Moreover, as shown in FIG. 10b, the vehicle detail summary screen 1000 provides the user with specific information with regard to the specific vehicle. In addition to providing a plurality of criteria 1002, including photos 1004a-c from which to appraise the worth of the vehicle, the system of the present invention provides a recommendation 1006 which apprises the user whether the particular vehicle fits with an ideal inventory model developed with the use of historical analysis of previous sales at a particular dealership. This is a unique aspect of the present invention. While national and even regional appraisal guidebooks are informative in determining the proper appraisal of a vehicle, the system of the present invention go a step further by determining a model inventory based upon an analysis of historic buying and selling trends.

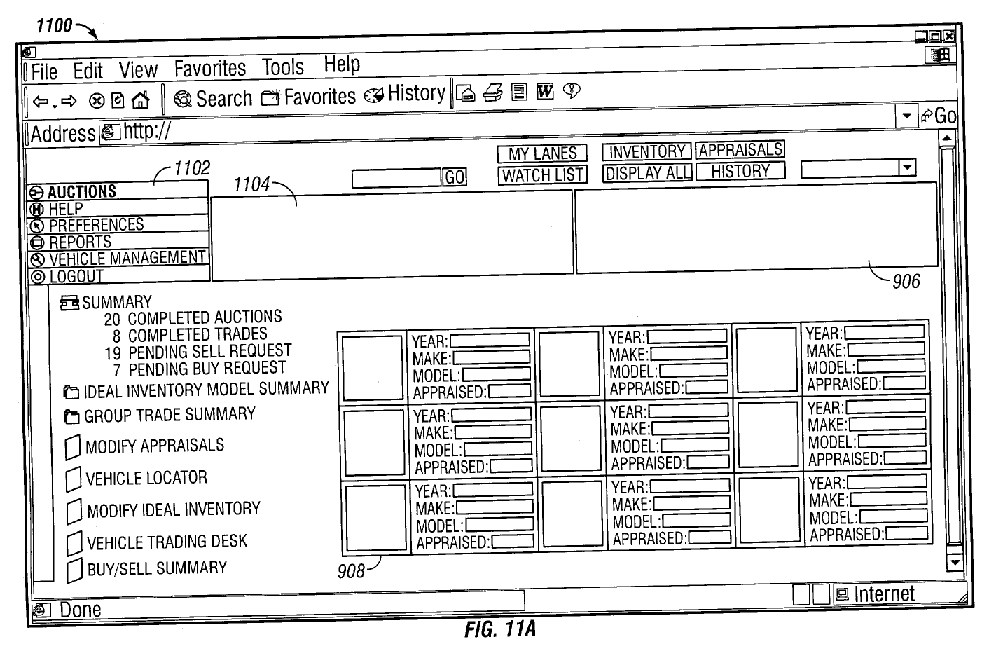

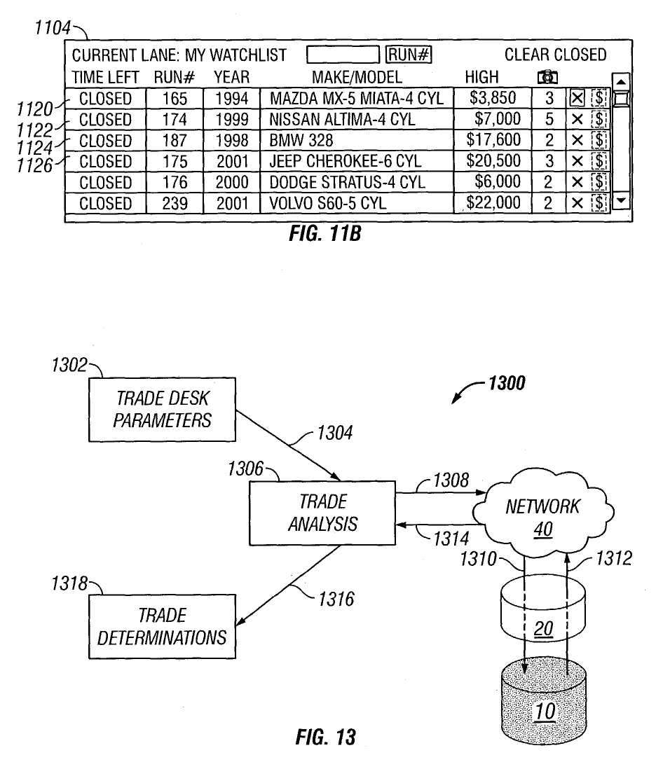

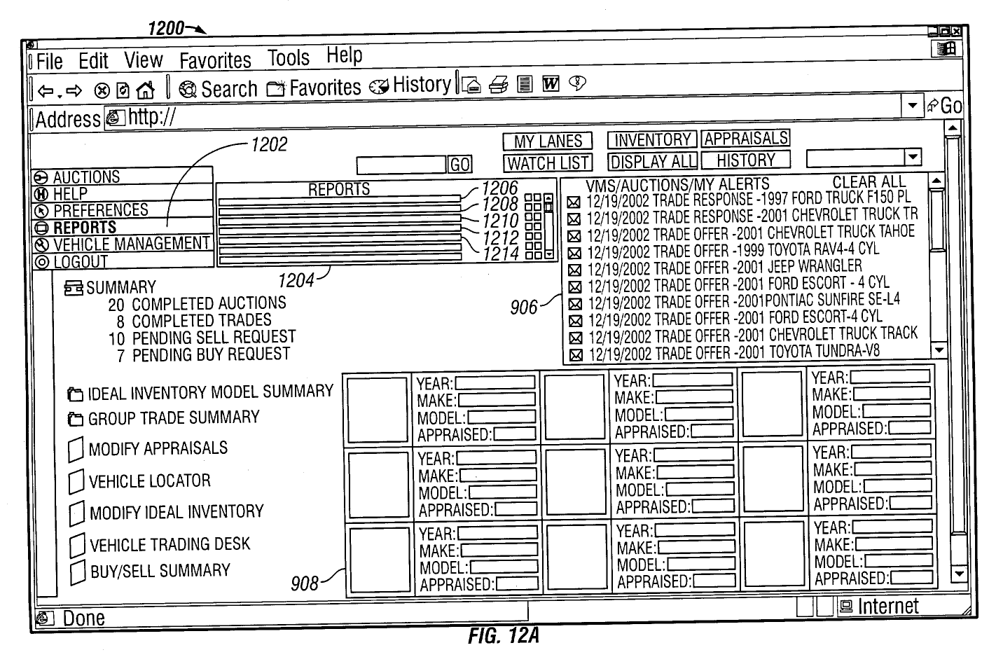

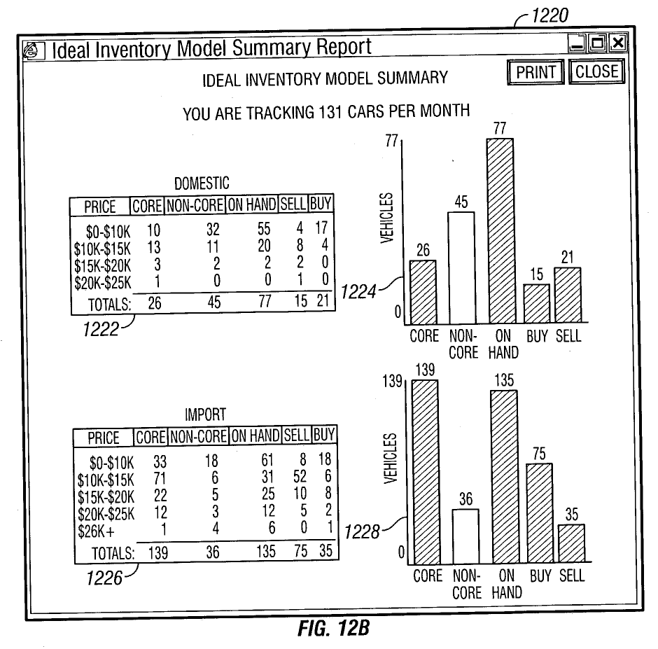

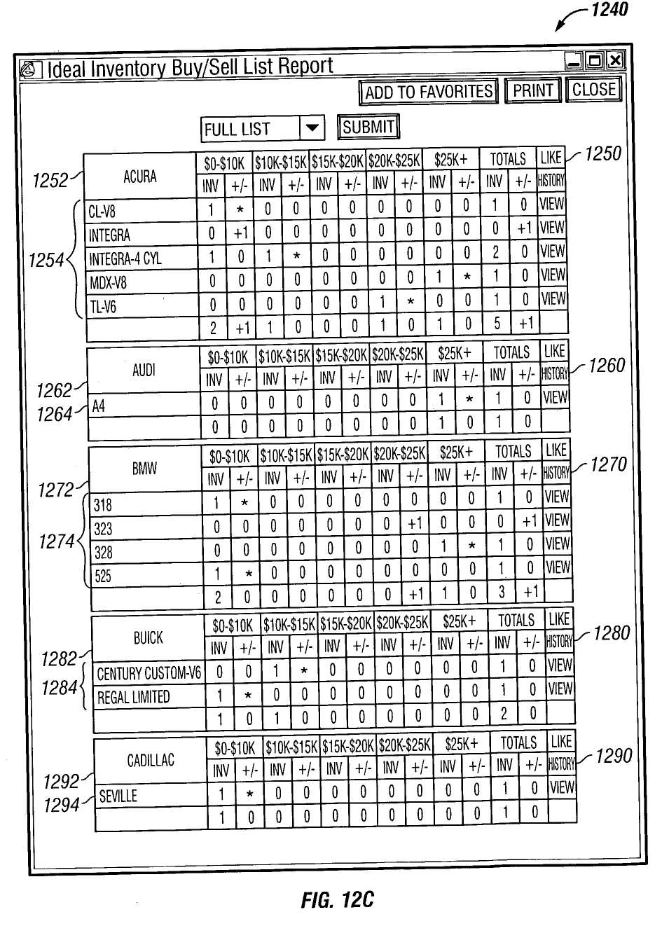

FIG. 11a and 11b illustrates an auction vehicle detail screen layout 1100 displayed to a user connecting to an embodiment of the system of the invention over a computerized network. The screen layout is organized in much the same way as the Vehicle Management screen layout. A watchlist summary screen 1104 is embedded in the auction display screen layout 1100. The watchlist summary screen 1104 includes a summary of pertinent auction information. As with the vehicle summary screen 904, the lines of vehicles 1120, 1122, 1124, 1126, etc. watchlist summary screen 1104 are hyperlinked to more detailed information screens. FIG. 12a illustrates a reports detail screen layout 1200 including a reports summary screen 1204 embedded therein displayed to a user connected to an embodiment of the system of the invention over a computerized network. Upon actuating one of the reports 1206, 1208, 1210, 1212, 1214, etc., the user is able to view more detailed analysis of buying and selling trends. Referring now to FIGS. 12b-c, the display screens of the Ideal Inventory Model Reports are illustrated. The reports can be either graphical summaries 1220 as in FIG. 12b or detailed statistical analysis 1240 as shown in FIG. 12c. Thus, the system of the present invention is able to generate useful “snapshot” impressions of sales trends as well as track trends over lengthy periods of time. By developing such Ideal Inventory Models, the system of the present invention give the user a tremendous advantage in effectively appraising the value of a particular vehicle for each dealer's particular circumstances.

Finally, as an added benefit generated from this Ideal Model Analysis, FIG. 13 illustrates the workflow of an embodiment of the system illustrating the process embodied in the Vehicle Trade Desk functionality 1300 of the present invention. The Vehicle Trade Desk functionality 1300 of the present invention allows the user to program parameters 1304 into a trade analysis such that he can efficiently procure vehicles which match his Ideal Inventory Model and dispose of vehicles which do not match his Model. Utilizing the Vehicle Trade Desk functionality 1300, the VMS Application Server 20 correlates all of the various Ideal Inventory Models of the various clients contained in the VMS database 10 to efficiently produce reports which match-up users with vehicles which match their Ideal Inventory Model. Thus, while a particular vehicle may not fit one dealer's model it might well be the perfect match for another dealers.

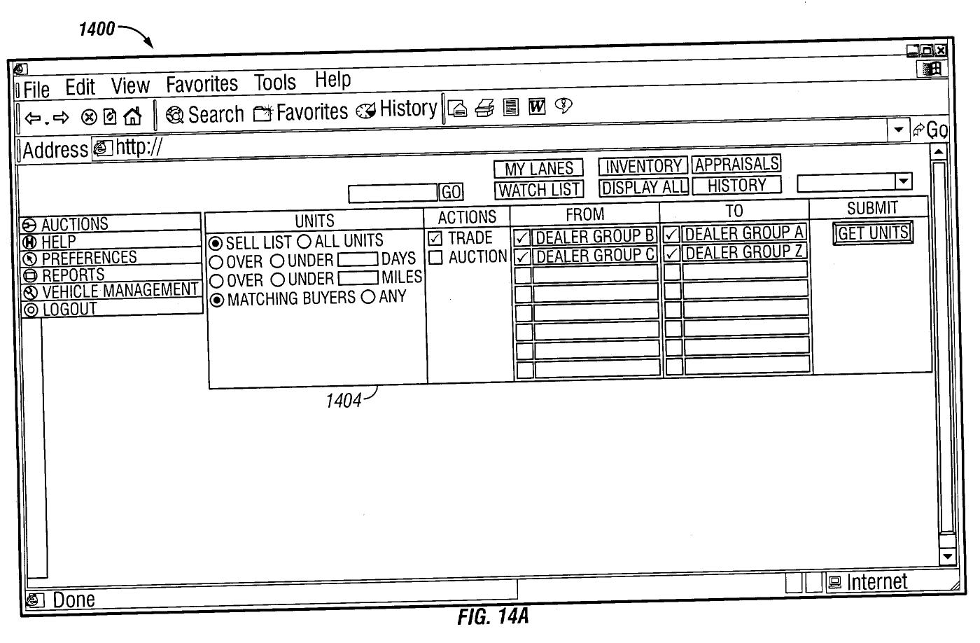

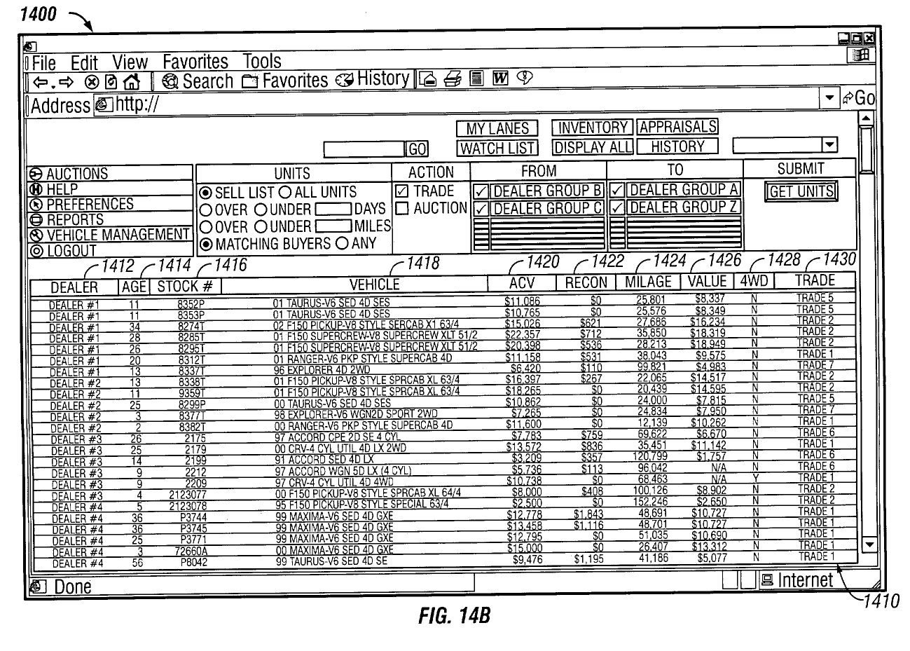

As shown in FIGS. 14a-b, the Vehicle Trade Desk screen layout 1400 includes a parameters window 1404 which allows the user to search the inventories of affiliated and non-affiliated Dealer Groups to ascertain where the vehicles are which match his Ideal Inventory Model. Upon activating a search, the system efficiently presents an organized itemization of possible vehicles for the user to view. The summary window 1410 shown in FIG. 14b illustrates how efficiently the system is at recommending the right vehicle to the right dealer. The summary display 1410 includes the location of the vehicle 1412, how long it has been on that dealer's lot 1414, the block number 1416, the ACV 1418, estimated costs of repair 1422, mileage 1424, the resulting estimated value 1426, and finally, a recommendation 1430 on how well the vehicle matches a user's Ideal Inventory Model.

It will now be evident to those skilled in the art that there has been described herein an improved data management system specifically adapted to maximizing the operational efficiency of used-car departments.

Although the invention hereof has been described by way of a preferred embodiment, it will be evident that other adaptations and modifications can be employed without departing from the spirit and scope thereof. For example, some of the steps in the system procedure could be conducted mechanically in addition to those conducted electrically. The terms and expressions employed herein have been used as terms of description and not of limitation; and thus, there is no intent of excluding equivalents, but on the contrary it is intended to cover any and all equivalents that may be employed without departing from the spirit and scope of the invention.

1. A method for assessing the value of a vehicle at a dealership location comprising in combination:
inspecting said vehicle by evaluating a plurality of vehicle characteristics;
appraising a potential market value of said vehicle based upon the evaluation of said characteristics; and
recommending the value of said vehicle based upon whether vehicle is kept at said location or traded wholesale, wherein said recommendation is based upon a historical analysis of selling trends at the particular location.

2. A method for appraising a used vehicle at a location comprising the steps of:
(a) inspecting said vehicle, wherein said step comprises
(i) creating a vehicle data file on said vehicle comprising evaluating a plurality of vehicle characteristics,
(ii) transferring said data file to a third-party data base;
(b) appraising the vehicle by analyzing a data model, wherein said model reflects historical purchase trends at the location; and
(c) recommending the value of a vehicle at the location based upon said appraising step.

3. A method for managing an inventory of used vehicles at a particular location comprising the steps of:
(a) appraising said inventory, wherein said step comprises
(i) creating a vehicle data file on each vehicle in said inventory comprised of an evaluation of a plurality of vehicle characteristics,
(ii) transferring each said data file to a third-party data base;
(b) creating an ideal inventory model for said location based upon an historical analysis vehicle data files of past sales over a specified period; and
(c) determining a current sales price of each vehicle in said inventory based upon an analysis of said model.

4. A method for updating the appraised value of an inventory of used vehicles at a particular location comprising the steps of:
(a) appraising said inventory, wherein said step comprises
(i) creating a vehicle data file on each vehicle in said inventory comprised of an evaluation of a plurality of vehicle characteristics,
(ii) transferring each said data file to a third-party data base;
(b) creating an ideal inventory model for said location based upon an historical analysis vehicle data files of past sales over a specified period; and
(c) recommending a current sales price of each vehicle in said inventory based upon an analysis of said model.
